(19) United States
(12) Patent Application Publication
(10) Pub. No.: US 2005/0028109 A1
(43) Pub. Date: Feb. 3, 2005

(54) Product classification system and method for retail sales

(76) Inventors: Seth Allen Richards, Chapel Hill, NC (US); Todd Robert Vore, Raleigh, NC (US)

Correspondence Address: BUCHANAN INGERSOLL PC, 1835 MARKET STREET, 14TH FLOOR, PHILADELPHIA, PA, 19103-2985, US

(21) Appl. No.: 10/628,547

(22) Filed: Jul. 28, 2003

(51) Int. Cl. G09G 5/00

(52) U.S. Cl. 715/823; 715/841

(57) ABSTRACT

The invention is a system and method in which a plurality of consumer products is organized into “use” groups, and these groups are conveyed to a consumer through color-coding and icons situated on an information layout. The information layout is provided on the product packaging, or proximally located near the actual products in a store or pictures of the products on an electronic display. In a particular embodiment, the products are footwear-related products, such as socks, insoles, shoes, and shoe-care products, and the “use” groups are “Comfort”, “Performance”, and “Outdoor”.

### FIELD OF THE INVENTION

The present invention relates generally to the field of consumer goods, and specifically to a system and method for classifying and displaying consumer goods based on the desired “use” of those goods to enable efficient consumer purchase of related goods. More specifically, the present invention relates to a system and method for classifying and displaying footwear-related consumer goods based on the desired “use” of those goods.

### BACKGROUND

The competitive world of retail clothing sales is fierce, and merchants gain competitive advantage if consumers are enticed to buy more than one product in a single transaction. Consumers are more likely to spend time in a store, when they can purchase items in a quick and organized fashion. Generally, systems exist for either classifying or displaying articles of clothing. However, no systems or methods exist for coordinating products based on how consumers will use those products, i.e. the desired performance of consumer products.

Mazzorato (U.S. Pat. No. 5,174,537) describes a support for displaying prices and other information. This support is intended particularly for clothing displays. De Leu (U.S. Design Patent Des. 327,173) describes a wall-mounted display rack for clothing. Frye (U.S. Pat. No. 6,349,863 B1) presents a combination of a hanger and a display panel for supporting clothing in a retail environment. Gouldson (U.S. Pat. No. 5,944,237) describes a method and system for classifying and displaying clothing according to sizes. Size categories are indicated by colored attachments on clothes hangers.

Only the Gouldson patent combines a classification scheme with a clothing display, enabling a consumer to find various distinct, separate articles of clothing (e.g. coats and trousers) which are likely to fit. However this classification system is based only on size.

The present invention provides a novel system and method of classifying closely related articles based on the intended type of consumer use. Specifically, footwear-related goods, including socks, insoles, and shoe-care products are classified based on types of consumer “use”, enabling consumers to easily and efficiently select a combination of those items to enhance consumer satisfaction with the goods. Information for the consumers is clearly displayed either on the products themselves, on a separate “information guide” strategically located for consumer reference, or on both, further permitting ease of consumer selection and purchase of related goods.

### SUMMARY OF THE INVENTION

The present invention is a system and method in which a plurality of consumer products are organized into product groups, and the identities of these product groups are conveyed to a consumer through icons situated on the product packaging. Optionally, other information about the product groups is provided on the product packaging, to inform consumers of the particular advantages of that product group. Product group information may optionally be-laid out near the products but not directly on the product packaging. Icons, colors on the icons and product packaging, and product group information all direct consumers to a combination of products designed to work together to provide consumers with a result based on the desired use for the products. Alternatively, the group icons, colors, and product information appear on an electronic display device, such as a computer monitor screen, enabling the consumer to purchase the desired products and combinations of products virtually, e.g. through the Internet.

In one embodiment, the present method links features and benefits of footwear-related products. In a particular embodiment, the present method links features and benefits of shoe insoles and socks. These two products are each manufactured in a number of designs. Each design is optimized for a particular activity or “use”. For example one design may be optimized for exercise or athletics, while another may be optimized for comfortable everyday wear. Thus, combinations of socks and insoles, for example, designed for the same use will work in tandem for optimal “use” and “performance” according to the desired consumer activity. The consumer's attention is directed to combinations of these and other footwear-related products through the use of color coding and icons specifically designed to represent each consumer activity.

The organization and coordination of footwear-related products is presented to consumers using a point-of-sale display. This display, according to the present invention, can be a display wall, rack, or other type of organizing structure in a traditional “bricks and mortar” store, or an electronic display such as a “virtual” display on a web site. In a traditional bricks-and-mortar store, the display is a wall, grouping of shelves, hanging rack, or other physical structure that holds goods such as socks, insoles, or other consumer goods in an organized and orderly fashion, such as by hanging or organizing in orderly piles. A physical display structure is constructed of a vertical member and optimally one or more horizontal members. The vertical member can be a wall, rod, or device capable of supporting the actual consumer products that are available for sale. Horizontal members are optimally connected to the vertical member to provide surfaces from which to attach, hang, or otherwise operably display the consumer products, such as using shelves, hooks, rods, hangers, Velcro or tape. The icons and other product information may be provided on the point-of-sale display itself or situated nearby to help consumers with product selection and coordination of similar products in the same group.

It will be readily understood by one of skill in the clothing and footwear industry that this method of classifying consumer articles based on activity or desired “use” is highly advantageous to both merchants and consumers in various industries and not particularly limited to footwear and related goods.

### BRIEF DESCRIPTION OF THE FIGURES

FIG. 1 is an example of product packaging for a “Comfort” use group insole.

FIG. 2 is an example of an icon for the “Comfort” use group.

FIG. 3 is an example of product packaging for a “Performance” use group insole.

FIG. 4 is an example of an icon for the “Performance” use group.

FIG. 5 is an example of product packaging for an “Outdoor” use group insole.

FIG. 6 is an example an icon for the “Outdoor” use group.

FIG. 7 illustrates a point-of-sale display with an accompanying information guide, showing product use group classification and other product attributes.

### DETAILED DESCRIPTION OF THE INVENTION

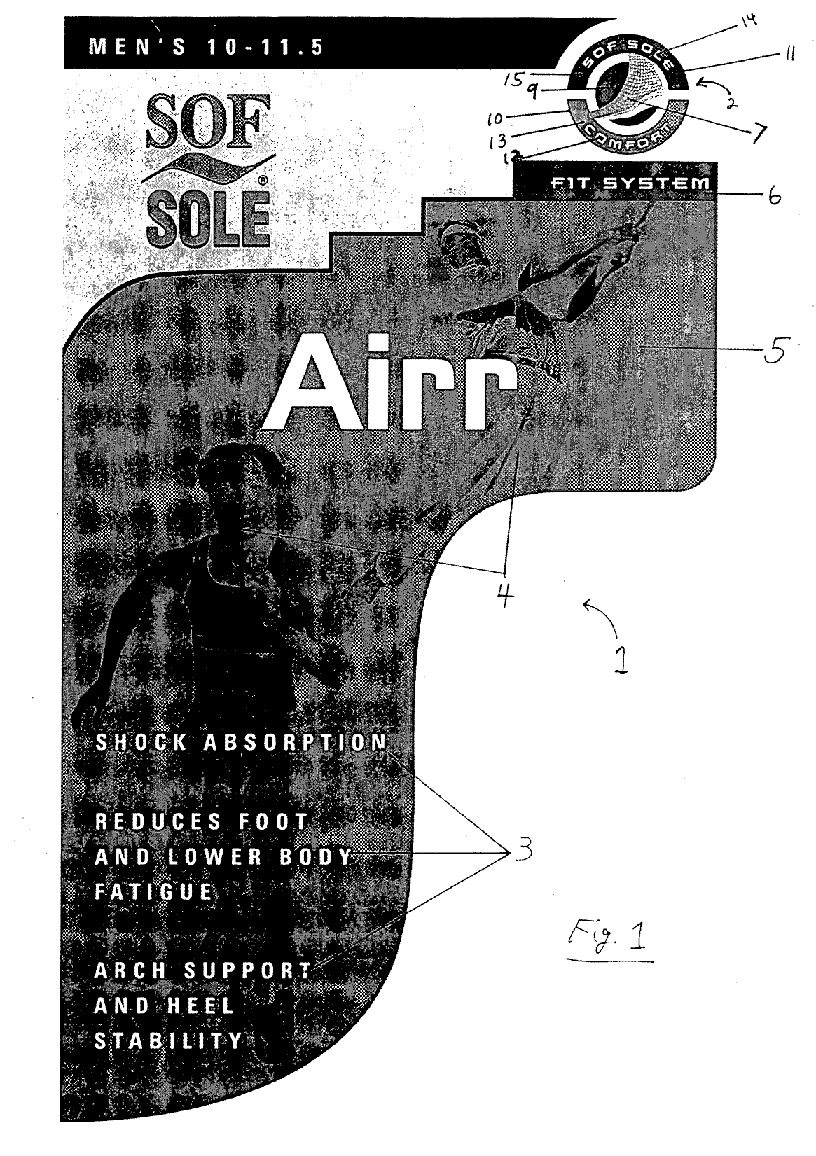

Referring now to the Figures, the present invention uses product information and icons to classify goods and aid consumers in the purchase of one or more products based on the consumers' desired “use” of the products. FIG. 1 illustrates an example of a product packaging label 1 for a “Comfort” use group product, specifically, a shoe insole. A label such as this is readily affixed to the outside of the product packaging. The product packaging label 1 includes a circular icon 2, product information 3, and packaging graphics 4. A packaging background 5 includes a specific color, depending on which “use” group the product belongs to, and packaging graphics 4 which illustrate some of the activities that individuals purchasing this product may use the product for. In this case, as illustrated on FIG. 1, the insole is a “Comfort” product, and the packaging graphics 4 correspond to activities that may require comfortable shoe insoles, e.g. golf and running. The product packaging label 1 also contains reference to the “Fit System” 6 of product classification of which this product is a part.

As illustrated on FIG. 1, icon 2 is an example of the type of icon on a product packaging label 1 that makes up part of the Fit System. In the case of the Examples provided on FIGS. 1 through 3, the icon 2 contains a graphic of a human foot 7 which partially overlays a solid circle 9. The foot graphic 7 and solid circle 9 are in turn surrounded by two semi-circular graphics 10 and 11, which contain backgrounds of solid-color and overlays of text. Portions of the solid-color background and of the text together convey to a consumer which of the several use groups the product belongs to. For example, referring to FIG. 1, the icon 2 in this instance has a lower semi-circular graphic 10 containing the text “COMFORT” 12 and a solid-color background 13. The solid color of the background 13 is of a color which appears only on labels, displays, or guides which refer to the “Comfort” use group. Still referring to FIG. 1, the icon 2 further has an upper semi-circular graphic 11, which contains the text “SOF-SOLE” 14 and a solid-color background 15, of a color distinct from that of the lower semi-circular graphic 13. Alternatively, solid-color background 15 may be the same color as background color 13 of the upper semi-circular graphic 11.

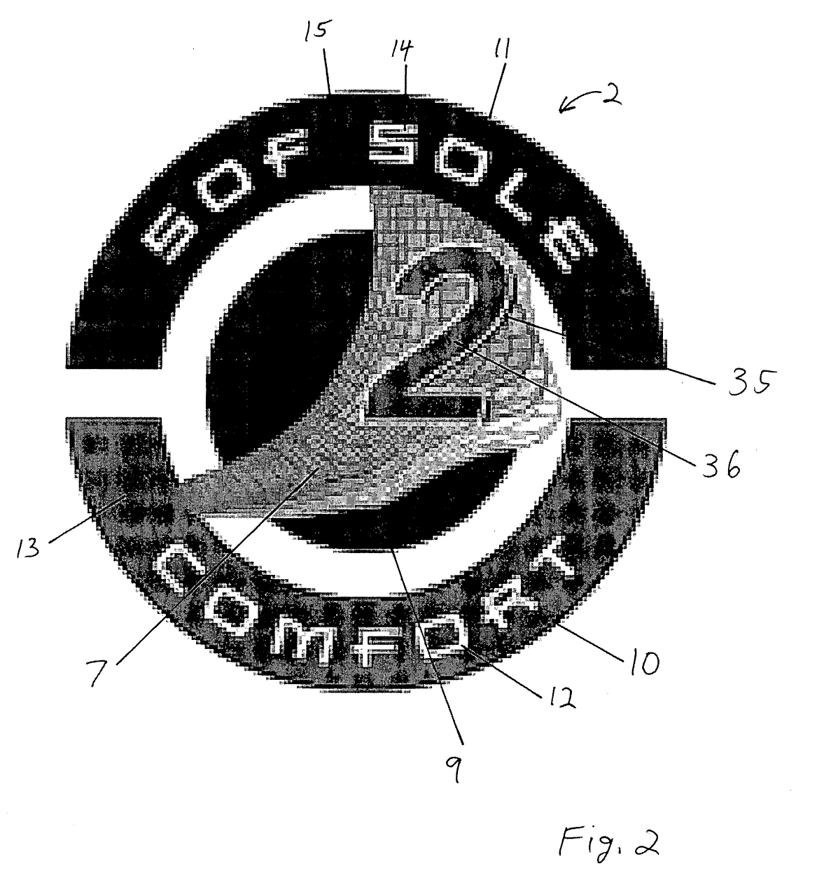

FIG. 2 shows an icon 2 for the Comfort use group in more detail. In this alternate embodiment a numeral 35, in this case “2”, acts as an additional indicator of the particular use group, in addition to the text 12, and colors of the icon background 13 and packaging background 5. To further enhance use group identification, the numeral 35 optionally has a solid-color filling 36, the solid color being the same as the colors of the icon background 13 and packaging background 5. The use of numbers as part of the Fit System classification method of the present invention makes it even easier for consumers to identify and associate products based on use group and to purchase multiple goods in that group.

It will be understood by those of skill in the art that the scope of the graphics contemplated for each use group icon in accordance with the present invention is not limited in any way by the icon 2 as illustrated for the use groups in FIGS. 1-6. For example, icon 2 may be a triangular shaped graphic containing text, color, and additional graphics that represent the particular use group in question. According to another embodiment, icon 2 may contain only human foot graphic 7 and solid circle 9. The graphics provided in FIG. 1 and FIG. 2 are therefore mere examples of that which may form a part of a “Comfort” use group icon.

According to one embodiment of the present invention, the packaging background 5, as illustrated on FIGS. 1, 3, and 5, includes color which may be the same as the color or colors used in the icon 2 associated with the use group for that product—exemplified in FIG. 1 by the color of the background 13 in the lower semi circular graphic 10. Coordinating the packaging background 5 color with one or more of the colors used in the icon 2 (shown on FIGS. 1-6) for a particular use group reinforces the association of that color with the particular use category for that product and enhances a consumer's recognition of, and desire to purchase, multiple products within a particular use group. Importantly, a different color is used for each use group icon 2 and each corresponding packaging background 5 such that consumers are able to distinguish between the use groups. For example, referring to FIG. 1, the “Comfort” group may be distinguished by the color blue as part of the graphics that make up the “Comfort” use group icon 2 and the packaging background 5, while red may be used for the “Performance” use group, and green may be used for the “Outdoor” use group. It should be understood that the scope of the present invention is not limited to these particular colors or the use of color at all as part of the icon 2 graphics and packaging background 5.

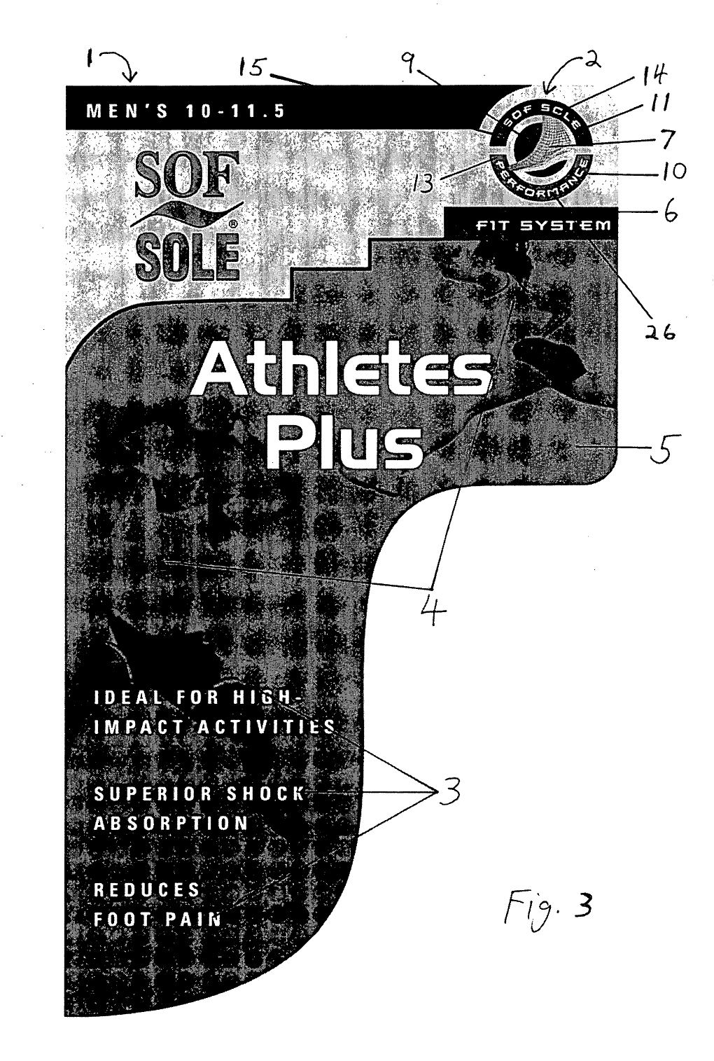

FIG. 3 illustrates a product packaging label 1 for a shoe insole which contains an icon 2, product information 3, packaging graphics 4, and a packaging background 5 of a particular color. Alternatively, the packaging background 5 can be white, or no color. Icon 2 according to this example has a specific “Performance” background color 13, and the text “PERFORMANCE” 26 as part of a lower semi-circular graphic 10. Also present is the text “SOF SOLE” 14 as part of an upper semi-circular graphic 11.

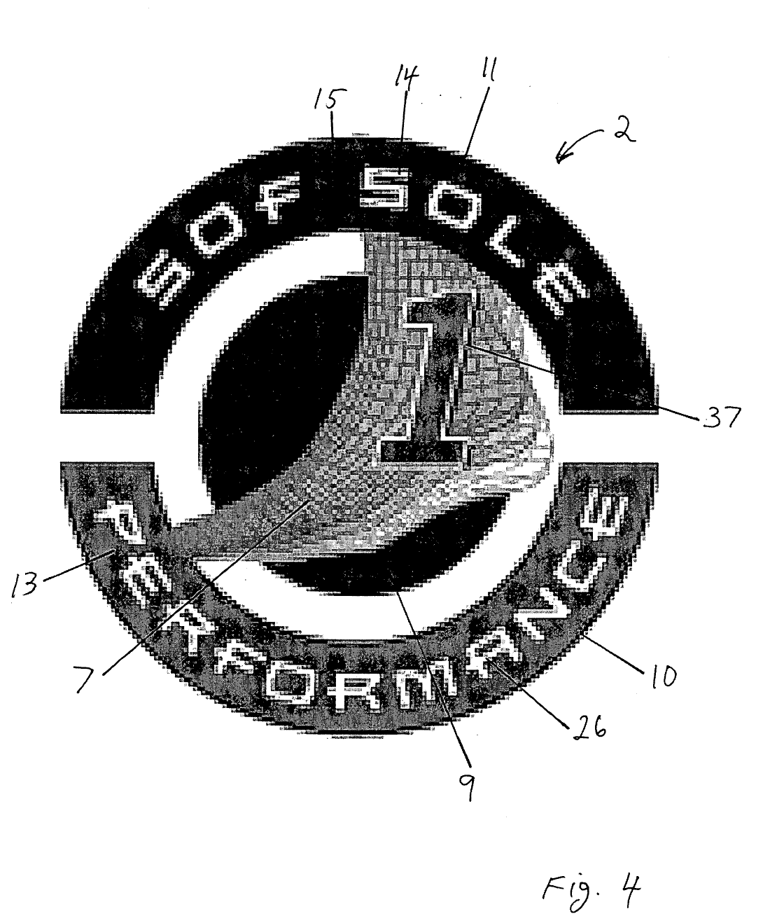

FIG. 4 shows an alternate embodiment for the “Performance” use group icon, including the numeral 37 identifying the use group, in this case the numeral “1”.

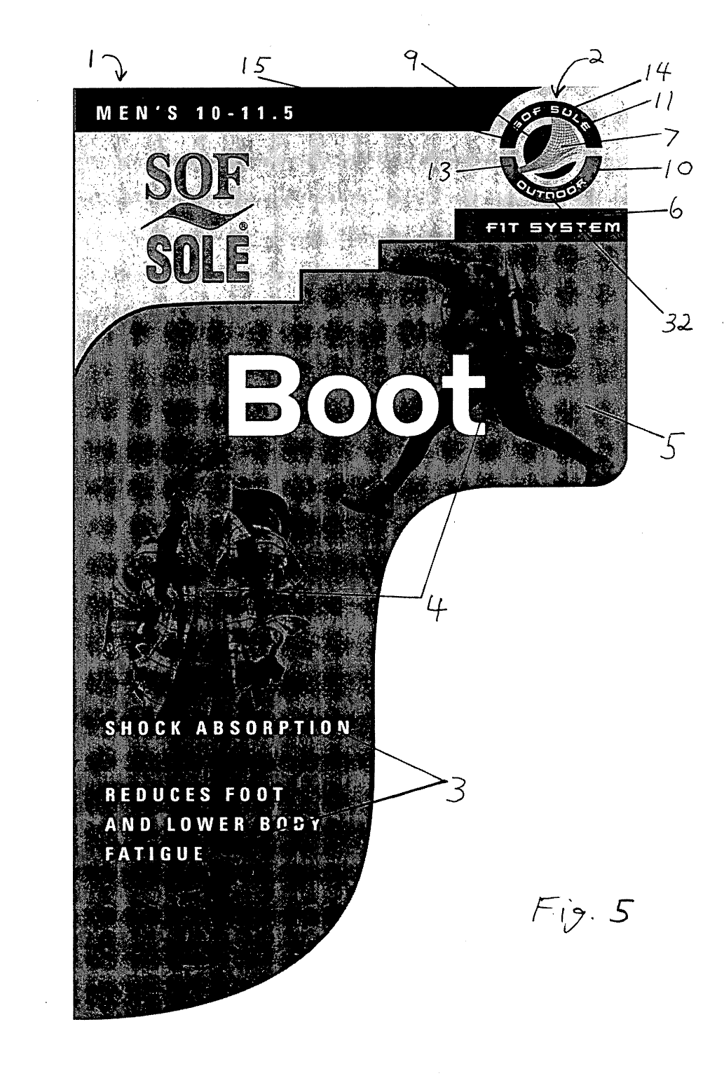

As illustrated on FIG. 5, one example of product packaging label 1 for an “Outdoor” use group shoe insole is similar to those shown on FIGS. 1 and 3 for other use groups. The text “OUTDOOR” 32 as part of the lower semi-circular graphic 10 indicates the “Outdoor” use group.

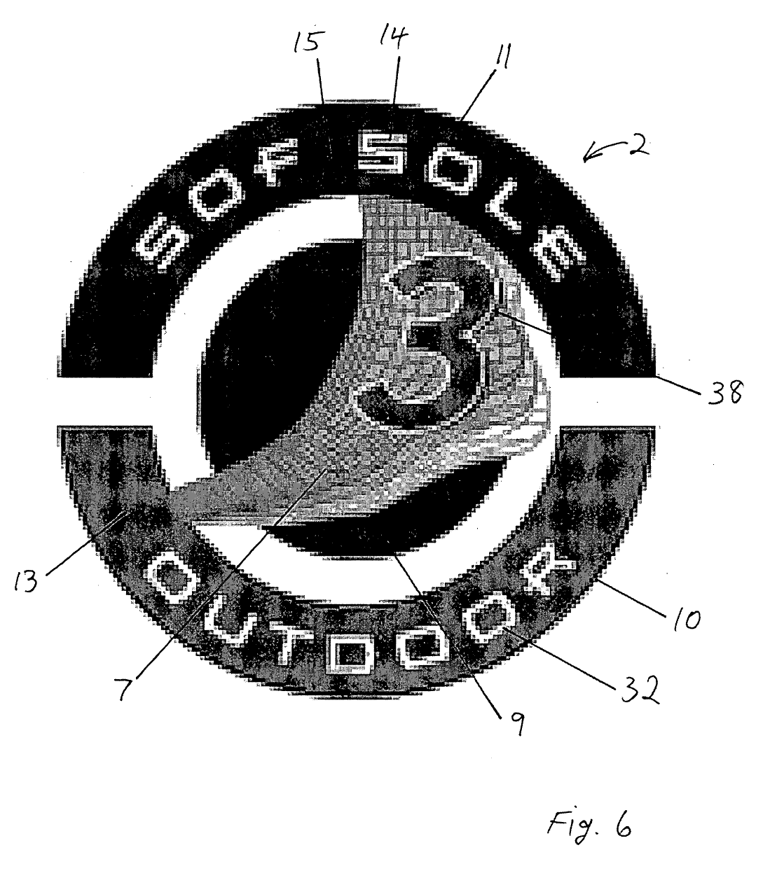

FIG. 6 shows an alternate embodiment of the icon for the “Outdoor” use group icon, including the numeral 38 identifying the use group, in this case the numeral “3”.

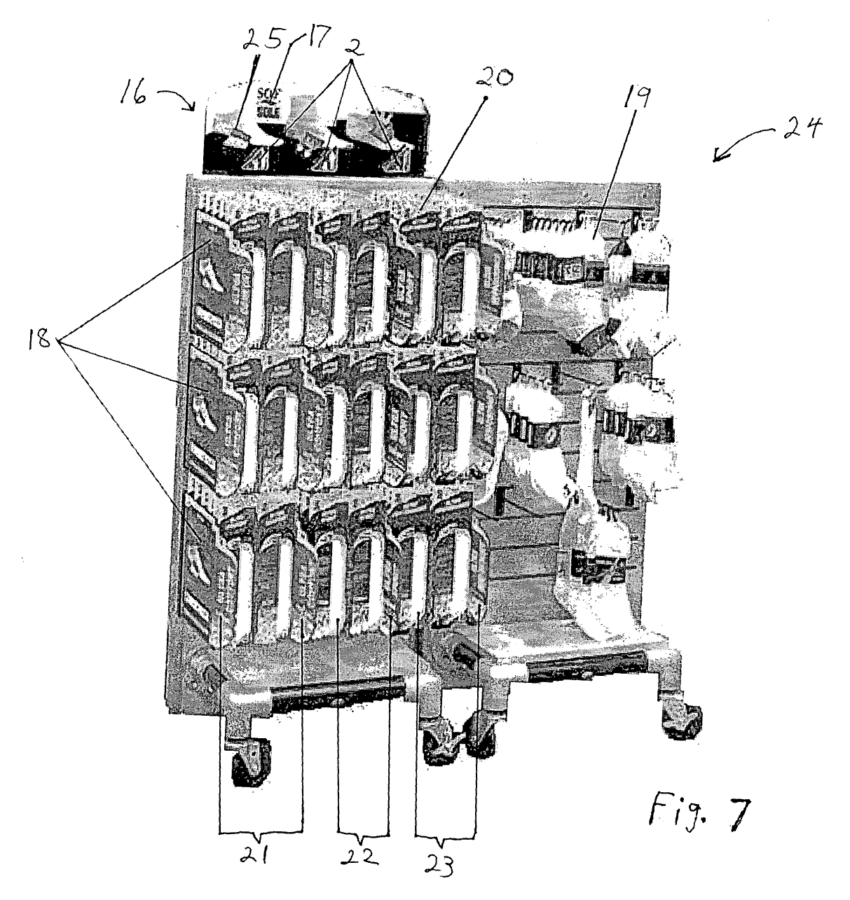

In addition to providing product information 3 on product packaging label 1 (see FIG. 1), the present invention includes one or more information guides provided on or near a point-of-sale display. One possible embodiment of such a guide and point-of-sale display is shown in FIG. 7 as a rack 24 that holds and/or displays the consumer products. Attached to the rack 24 are a main information guide 16 and other information panels 18. The main information guide 16 optimally includes an icon 2 for each use group, and optionally includes product graphics 25 and other product information. For example, as illustrated on FIG. 7, a main information guide 16 providing an icon 2 for each use group, product graphics 25 of human feet with socks on them, with the “SOF SOLE” logo 17. Information panels 18 provide additional information about the consumer products. Such information can be product sizes, product qualities, prices, etc. It will be understood by those of skill in the art that a main information display 16, information panels 18, and other forms of information displays located at or near the products being offered for sale are not limited to the types or styles of information displays illustrated in FIG. 7 and are not limited by the types of information listed herein.

According to the example provided on FIG. 7, display rack 14 holds products that are spatially grouped by product type, namely socks 19 and insoles 20. Within each product type, articles are further spatially located based on use group. For example, those insoles 20 in the use group “Comfort” are located together in product rows 21, all those in the use group “Performance” are located together in product rows 22, and all those in the “Outdoor” use group are located together in product rows 23. The socks 19 are similarly separated spatially according to the same use groups. As explained previously, both the insoles 20 and the socks 19 belonging to a given use group are labeled with a common color and a common icon 2, and this color and icon 2 match those in the corresponding part of main information guide 16. Thereby, a consumer can quickly pick out and remove from the rack 24 both an insole and socks which together provide the optimum combination for a particular use, thus benefiting the consumer and providing additional sales for the merchant.

According to the example provided in FIG. 7, display rack 14 is a moveable rack that provides for horizontal rods on which products are hung, for example, using hangers or hooks attached to the rods themselves, or attached to the actual product packaging 1 of each product. Options for displaying the products on the rack 14 are many, including shelves, hooks, rods, hangers, Velcro, and tape and any combination of these, that supports and displays the consumer products that are sold as part of the Fit System.

Preferably, the Fit System consumer products are displayed on a moveable display rack 14, as illustrated in FIG. 7, where the product packaging 1 for each product has a built in hanger or “holder” which allows the product to be hung on horizontal rods for display. This one embodiment of the present invention is illustrated in FIG. 4.

Alternatively, products are situated throughout a bricks and mortar store, or images of products are provided for consumer purchase through computerized methods such as on a web site. In these cases, the appropriate icon 2 for the use group that each product belongs to is situated on the product packaging label 1 so that consumers are able to match different products in the same use group. Optionally, additional information guides are provided on product packaging label 1, or in opportune locations throughout the store or web site, so that information about each product is available to the consumer, and the product can be matched according to use category using icon 2.

For example, according to one embodiment, a web site lists and offers for sale products advertised as part of the SOF SOLE Fit System. Consumers use the web site to purchase socks, insoles, and other footwear-related products belonging to the “Performance” use group. Referring to FIG. 3, using the icon 2 that is associated with the “Performance” group, the consumer will be able to select socks and insoles belonging to that group. Additional product information is available for review on the web page or web pages selected by the consumer. Additionally, the consumer is able to view the product packaging 1 that may include additional product information 3, packaging graphics 4 and packaging background 5 of a particular color that matches a color or colors in the icon 2.

Numerous use groups are contemplated according to the present invention. Such groups are based on desired use and performance of the groupings of consumer products. “Sub-groups” within each group are also contemplated as part of the present invention. For example, “Comfort Cushion”, “Comfort Light”, “Performance Cushion”, “Performance Light”, “Outdoor Cushion” and “Outdoor Light”. These groups and sub-groups illustrate some of the “use” diversity of consumer products such as socks, insoles, and other footwear-related products. It will be understood by one of ordinary skill that the scope of the present invention is not limited to these categories and that many different uses are contemplated for the current system and method of classifying consumer goods by use and desired performance.

The foregoing description provides only an exemplary embodiment of the present invention for the purposes of illustration and not limitation. It will be readily apparent to those skilled in the art that the embodiments described herein may be modified or revised in various ways without departing from the spirit and scope of the invention. The scope of the invention is to be measured by the appended claims.

1. A method for marketing products based on the intended use of said products, the method comprising classifying a plurality of products into a plurality of use groups based on the intended use of said products, then designating each of said use groups by one or more icons specific to each of said use groups, and displaying said products such that a consumer can select one or more products in each use group based on the one or more icons.

2. The method of claim 1 wherein said one or more icons designate said products using a combination of identifying features selected from the group consisting of text, graphics, color, texture, and a combination thereof.

3. The method of claim 2 wherein each one of said one or more icons comprises a foreground and a background, wherein said foreground comprises text, and graphics corresponding to a particular use group, said foreground text and graphics being in one or more colors, and wherein said background comprises background graphics in one or more background colors, said one or more background colors differing from said one or more foreground colors.

4. The method of claim 3, wherein
a first icon represents a first use group, the text of said first icon foreground comprising “SOF SOLE” and “COMFORT”;
a second icon represents a second use group, the text of said second icon foreground comprising “SOF SOLE” and “PERFORMANCE”; and
a third icon represents a third use group, the text of said third icon foreground comprising “SOF SOLE” and “OUTDOOR”.

5. The method of claim 4 wherein said first use group comprises “Comfort Cushion” and “Comfort Light” sub-groups, said second use group comprises “Performance Cushion” and “Performance Light” sub-groups, and said third use group comprises “Outdoor Cushion” and “Outdoor Light” sub-groups.

6. The method of claim 4, wherein said one or more background colors belonging to each of said first icon, second icon and third icon are different.

7. The method of claim 3 wherein said background graphics comprise a foot, a number, and at least one semi-circle in one or more colors, said at least one semi-circle providing the background for said foreground text.

8. The method of claim 1 wherein said products comprise footwear-related products, said footwear-related products comprising socks, insoles, shoes, and shoe-care related products.

9. The method of claim 2 further comprising utilizing the packaging of said products to represent each of said use groups and distinguish each of said use groups from one another.

10. The method of claim 9 wherein said packaging comprises product information, the icon specific to that product use group, packaging graphics, and a packaging background.

11. The method of claim 1 wherein said displaying is performed using a point-of-sale display.

12. The method of claim 11 wherein said point-of-sale display comprises a vertical member and a plurality of horizontal protrusions extending from said vertical member.

13. The method of claim 12 wherein said vertical member comprises a wall, rod, or stand.

14. The method of claim 12 wherein said horizontal protrusions comprises shelves, hooks, rods, hangers, Velcro, or tape.

15. The method of claim 11 further comprising displaying a main information guide to assist consumer selection of said consumer products wherein said main information guide comprises said one or more icons and printed information conveying the correspondence of said one or more icons to said respective use groups.

16. The method of claim 15 wherein said main information guide is situated on or near said point-of-sale display.

17. The method of claim 16 wherein said point-of-sale display comprises an electronic display.

18. The method of claim 17 wherein said electronic display comprises a digital or computerized display, said digital or computerized display comprising a screen and a plurality of images arrayed on said screen displaying said products and said main information guide.

19. A method for marketing consumer footwear-related products based on the intended use of said products, the method comprising:
classifying a plurality of footwear-related products into a plurality of use groups based on the intended use of said products;
designating each of said use groups with one or more icons specific to each of said use groups;
labeling said footwear-related products with said one or more icons representing said use groups;
displaying said products at a point-of-sale display; and
displaying a main information guide that provides said one or more icons such that a consumer can select one or more products in each use group based on the one or more icons.

20. The method of claim 19 wherein said main information guide is located proximally to said products.

21. The method of claim 19 wherein said products comprise socks, insoles, shoes, and shoe-care products.

22. The method of claim 19 wherein said use groups comprise “Comfort”, “Performance” and “Outdoor”, said use groups comprising “Comfort Cushion”, “Comfort Light”, “Performance Cushion”, “Performance Light”, “Outdoor Cushion” and “Outdoor Light” sub-groups.

23. The method of claim 19 wherein said one or more icons each comprise a foreground and a background, said foreground comprising foreground text and one or more graphics, and said background comprising background text and one or more graphics.

24. The method of claim 23 wherein said foreground text comprises “SOF SOLE” and the name of the use group for that product, and wherein said one or more background graphics comprises a foot, a number, and at least one semi-circle of one or more colors, said at least one semi-circle providing the background for said foreground text.

25. A system for selling consumer goods based on the intended use of said goods, the system comprising:
a plurality of use groups based on the intended use of said goods;
a display for said goods classified into said plurality of use groups;
at least one information guide depicting said use groups, wherein said use groups are represented by one or more icons specific to each of said use groups; and
product packaging information.

26. The system of claim 25 wherein said consumer goods are footwear-related products.

27. The system of claim 26 wherein said footwear-related products comprise socks, insoles, shoes, and shoe-care products.

28. The system of claim 25 wherein each one of said one or more icons designate said use groups using a combination of identifying features selected from the group consisting of text, graphics, color, texture, and a combination thereof.

29. The system of claim 28 wherein each one of said one or more icons comprises a foreground and a background, wherein said foreground comprises foreground text and graphics corresponding to a particular use group, said foreground text and graphics being in one or more foreground colors, and wherein said background comprises background graphics in one or more background colors, said one or more background colors differing from the one or more foreground colors.

30. The system of claim 25, wherein
a first icon represents a first use group, the text of said first icon foreground comprising “Comfort”;
a second icon represents a second use group, the text of said second icon foreground comprising “Performance”; and
a third icon represents a third use group, the text of said third icon foreground comprising “Outdoor”.

31. The system of claim 30 wherein said first use group comprises first sub-groups, said first sub-groups comprising “Comfort Cushion” and “Comfort Light”, said second use group comprises second sub-groups, said second sub-groups comprising “Performance Cushion” and “Performance Light”, and said third use group comprises third sub-groups, said third sub-groups comprising “Outdoor Cushion” and “Outdoor Light”.

32. The system of claim 30 wherein said at least one information guide comprises a main information guide located proximal to said goods and wherein said product packaging comprises one of said icons, product information, packaging graphics, and a packaging background color, said packaging background color being the same color as said one or more icon background colors.

33. The system of claim 25 wherein said display is a point-of-sale display, said point-of-sale display comprising a vertical member and a plurality of horizontal protrusions extending from said vertical member.

34. The system of claim 33 wherein said vertical member comprises a wall, rod, or stand.

35. The system of claim 33 wherein said horizontal protrusions comprises shelves, hooks, rods, hangers, Velcro, or tape.

36. The system of claim 33 wherein said point-of-sale display comprises an electronic display.

37. The system of claim 36 wherein said electronic display comprises a digital or computerized display, said digital or computerized display comprising a screen and a plurality of images arrayed on said screen displaying said products and said information guide.
